(19) United States
(12) Patent Application Publication
(10) Pub. No.: US 2008/0307105 A1
(43) Pub. Date: Dec. 11, 2008

(54) STREAMING MEDIA ARCHIVER FOR LIVE EVENTS

(75) Inventors: Aaron Cumar Sethi, Bellevue, WA (US); Robert Thomas Schumaker, Redmond, WA (US); Girish Naharaja, Kirkland, WA (US); Supin Ko, Seattle, WA (US); Vishal Mishra, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/760,954

(22) Filed: Jun. 11, 2007

(51) Int. Cl. G06F 15/16

(52) U.S. Cl. 709/231

(57) ABSTRACT

A system for recording media streams of live events, such as live meetings, is provided. The system acts as a passive client for one or more media streams of the live event but does not perform other functionality associated with the live event, such as presenting the media streams to a user. The system can be used by multiple content presenters, including third-party content presenters. Subsequently, the recorded media streams can be published for future asynchronous playback of the event.

### BACKGROUND

Telecommunications have significantly improved the ability of people to communicate with each other when a face to face event is impracticable. Live events, such as meetings, allow people in multiple locations to experience the same presentation. During these live events, it is often desirable to record the live event for future asynchronous playback. For example, if a company trains employees in a meeting, it is still possible that some employees cannot make the meeting due to illness, vacation, or urgent business. As a second example, recording the live event may present a business opportunity for the event sponsor, such as by allowing the event sponsor to give away or sell the event recording in the future.

Unfortunately, recording a live event while maintaining the same quality as the live broadcast is problematic. One reason for this is that recording of multimedia media streams has high resource requirements (e.g., memory, processor time, network bandwidth, etc.) associated therewith. These resource requirements are in addition to those requirements needed to perform other functionality associated with the live event. For example, if an attendee's computer is recording the live event, the recording functionality is in addition to the resources need to decode the media streams and present the content to the attendee. In addition, some live events, such as meetings, involve live communications from multiple locations. As a result, the media streams for at least one of the locations is subject to problems associated with network latency, even if the client is connected to a relative high-speed connection.

Furthermore, many solutions to recording live events are tightly coupled to particular types of media streams and/or specific types of hardware. As a result, there is added complexity in developing and maintaining recording solutions. In some cases, it can be nearly impossible to add a highly coupled archiver to an existing media producer. For example, if a third-party telephone solution is used, it can be hard to add the ability to record a telephone conference if the feature was not previously included.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

A recorder of live media streams in accordance with embodiments described herein provides for an improved recording of live events. The recorder can record one or more media streams on behalf of content providers. The recorder acts as a passive client running on its own computer. Since that computer does not need to also perform other functionality (e.g., presenting content to live event attendees or distribute media streams as part of the live event) related to the event, it can achieve higher quality audio/video recordings. Furthermore, the computer and network resources needed for real-time recording can be optimized when a machine's primary purpose is real-time recording. For example, the media archiver can be placed in close network proximity to the stream mixer and quality of service for receiving the data packets of the media stream at a higher priority can be controlled. The recorder can be a hosted online service or a service executing locally within a content provider's own network.

In addition, the archiver of live events is decoupled from the exact media stream type or equipment used. Hence, it is possible to use the archiver even when native recording functionality is not available in the audio/visual equipment used for presenting and/or mixing the streams. Thus, for example, a PSTN gateway can be used to record a telephone conversation even when the phone used by the presenter or the telephone conference backend does not offer live recording functionality.

The following description and the annexed drawings set forth in detail certain illustrative aspects of the claimed subject matter. These aspects are indicative, however, of but a few of the various ways in which the principles of the claimed subject matter can be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a schematic block diagram of an exemplary computing environment.

FIG. 2 depicts a block diagram of an example media archiver and the archive publisher according to one embodiment.

FIG. 3 illustrates various interactions between the components of the media archiver, as well as interaction with the MCU and a presenter client.

FIG. 4 depicts an XML request to start recording according to one embodiment.

FIG. 5 is a state diagram of the various states of the media archiver according to one embodiment.

FIG. 6 is a state diagram of a live event recording according to one embodiment.

FIG. 7 depicts an exemplary flow chart of procedures that record live events.

FIG. 8 is an exemplary flow chart of procedures during recording.

FIG. 9 illustrates a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,”“system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the term “media stream” refers generally to digital data streams and analog streams that may be converted to a digital stream, such as a phone call on the public switched telephone network (PSTN) that can be converted using a PSTN gateway. Media streams can be of various types, such as audio, visual, and/or data streams. The streams can be encoded using various encoding formats. The media streams can be controlled via various protocols, such as Real-time Transport Protocol (RTP) Control Protocol (RTCP), Session Description Protocol SDP, and Session Initiation Protocol (SIP). In at least some embodiments, multiple streams of different types are recorded and can be combined together in a post-processing phase before publication.

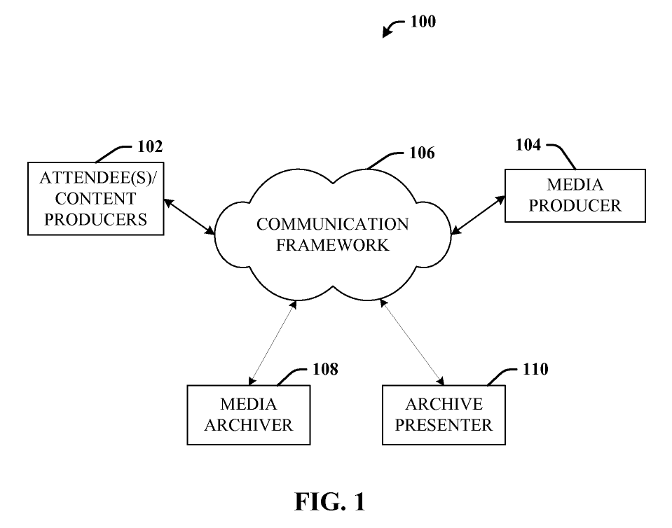

Referring now to FIG. 1, there is illustrated a schematic block diagram of an exemplary computer system operable to execute live event architecture. For the sake of simplicity, only a single machine of each type is illustrated, but one skilled in the art will appreciate that there can be multiple machine of a given type and that some of the types can have their functionality distributed between various computers. Furthermore, one will appreciate that a single machine can also host some or all of the processes of the other machine types. The system 100 includes one or more attendee client(s) 102. The attendee client(s) 102 can be hardware and/or software (e.g., threads, processes, computing devices). Attendees that use the attendee client 102 can be either regular attendees or presenters (hereinafter “content providers”). Multiple presenters can be present at a single location, such as at a roundtable and share one attendee client. Hardware, such as a roundtable camera, can be used to detect and focus on the current dominant speaker. In other embodiments, there can be presenters in disparate locations.

The system 100 also includes one or more media producer(s) 104. The media producer(s) 104 can also be hardware and/or software (e.g., threads, processes, computing devices). The media producer 104 can house threads to perform audio and/or video mixing and distribution, for example. In one embodiment, the media producer 104 can be a Multipoint Control Unit (MCU). In one embodiment, the media producer is hosted as an online service by the same entity as the media archiver service. One possible communication between an attendee client 102 and a media producer 104 can be in the form of data packets adapted to be transmitted between two or more computer processes. The data packets can include one or more media streams. For example, the attendee client can be a presenter that communicates one or more media streams to the media producer for live broadcast. As another example, the live broadcast of the live event can include one or more media streams from the media producer 104 to one or more attendee clients.

The system 100 also includes a media archiver 108. The media archiver can also be hardware and/or software (e.g., threads, processes, computing devices). In one embodiment, the media archiver 108 acts as a passive client to record the one or more media streams. In one embodiment, the media archiver is placed in close network proximity to the media producer 104. Close network proximity minimizes the latencies and the range of latencies in packet transmission between the media archiver and the media producer. Close network proximity can be determined in various manners, such as by logical network hops (e.g., within 2 virtual network hops), bandwidth (actual and effective) available between the computers, and the ability to maintain small and consistent latencies. Multiple media archivers 108 can be used for a single recording in some embodiments for failover or legal reasons (e.g., copyright laws, or export control laws).

The system 100 also includes an archive presenter 110 that lets a user view the previously recorded event. The archive presenter can also be hardware and/or software (e.g. threads, processes, computing devices). In addition, the archive presenter can perform various post-recording processing, such as mixing the streams together or encoding the recorded streams into an appropriate format for viewing.

The system 100 includes a communication framework 106 (e.g., a global communication network such as the Internet; or the PSTN) that can be employed to facilitate communications between the attendee client(s) 102, media producer(s) 104, media archiver 108, and the archive publisher 110. Communications can be facilitated via a wired (including optical fiber) and/or wireless technology and via a packet-switched or circuit-switched network.

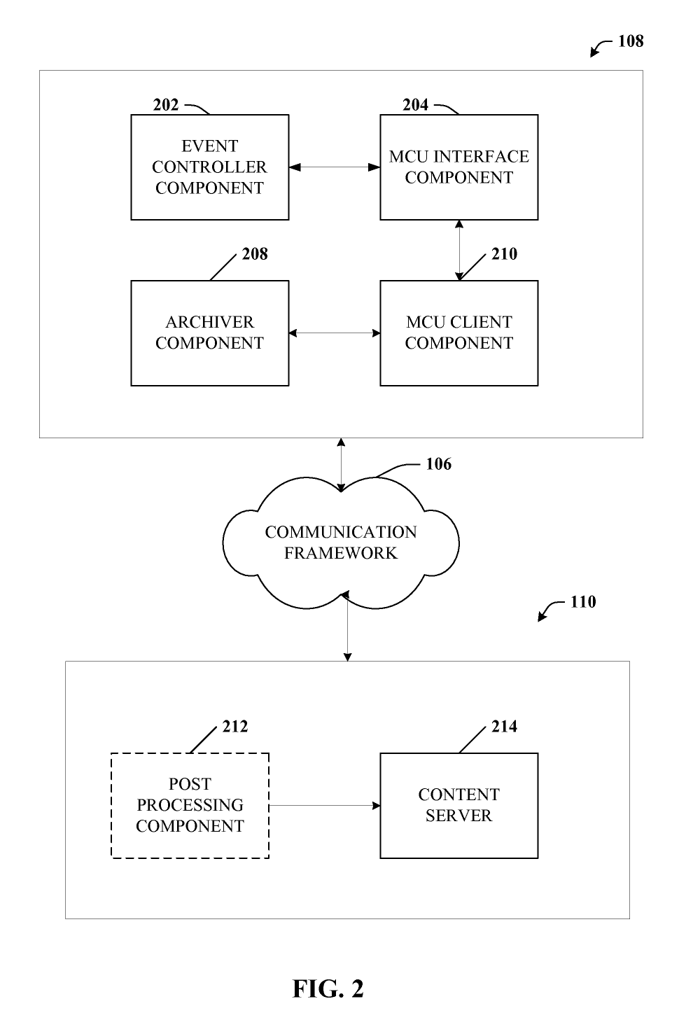

Referring to FIG. 2, FIG. 2 illustrates exemplary components of the media archiver 108 and the archive presenter 110 according to one embodiment. For the sake of clarity, only a single component is illustrated within a single system; however, one will appreciate that there can be multiple components of each type in at least some media archiver 108 systems and that the components can be distributed between different machines or processes.

As previously discussed the media archiver 108 and archive presenter 110 are connected together by a communication framework 106. The media archiver 108 contains an event controller component 202, a MCU interface component 204, an MCU client component 210, and an archiver component 208. The event controller component 202 controls multiple archiving sessions. For example, the event controller component 202 receives an indication to record an event having one or more media streams (e.g., from a content producer or a remote system) and allocates other components of the media archiver 108 system to record that event.

The MCU interface component 204 is an intermediary between the event controller component 202 and the MCU client component 210 and sets a number of parameters for a particular event. In one embodiment, the MCU interface component 204 receives some or all of the parameters from the content producer while other parameters can be set automatically, such as the location of where to store the raw recorded media streams. The MCU client component 210 maintains a connection to a MCU and can also generate metadata from events. In other embodiments, the MCU client component 210 can be replaced with another type of media client component for recording streams that do not traverse a MCU, such as a telephone conference captured via a PSTN gateway. The archiver component 208 records one or more media streams to a computer-readable storage medium. In one embodiment, the computer-readable storage medium is a remote computer-readable storage medium, such as network attached storage.

The illustrated archive presenter 110 has two components: the post-processing component 212 and the content server 214. In other embodiments, the functions of post-processing component can be performed by a computing system other than the media presenter 110. The post-processing component 212 processes the raw recorded streams and produces output suitable for presentation via the content server. Examples of post-processing can include audio/video encoding/transcoding or mixing audio/video. The content server serves the asynchronous recording of the event. Example content servers include Microsoft IIS, Real Networks Helix server, Apache HTTP server, etc.

In one embodiment, the media archiver is extended to facilitate producing more than one finished recording from a single recording of a live event. Multiple finished recordings are useful when the recordings are intended for different audiences or will be distributed separately. For example, a single meeting can have a public portion and an internal portion before or after the public portion and it can be desirable to produce a finished recording of the entire meeting, as well as just the public portion. In such an embodiment, the MCU client component records a set of metadata for each intended recording. Subsequently, the post-processing component can split up the single live event recording according to the metadata.

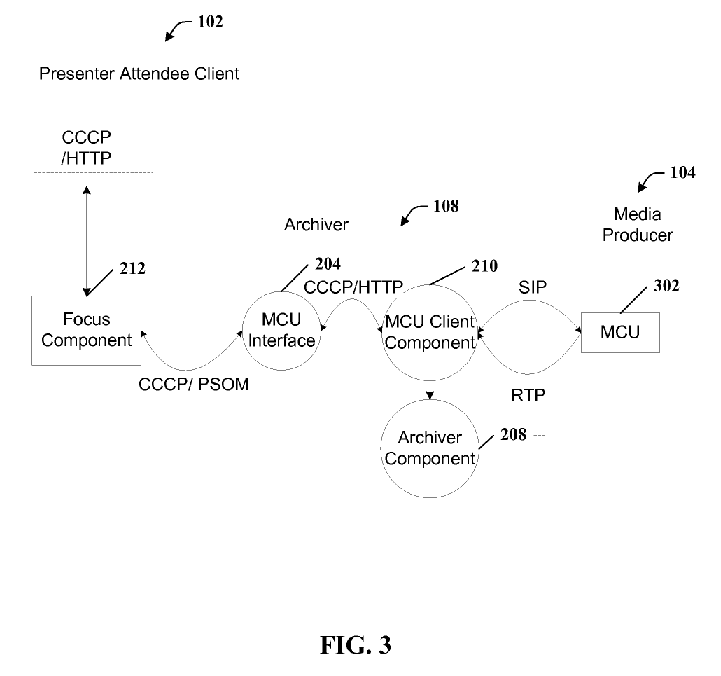

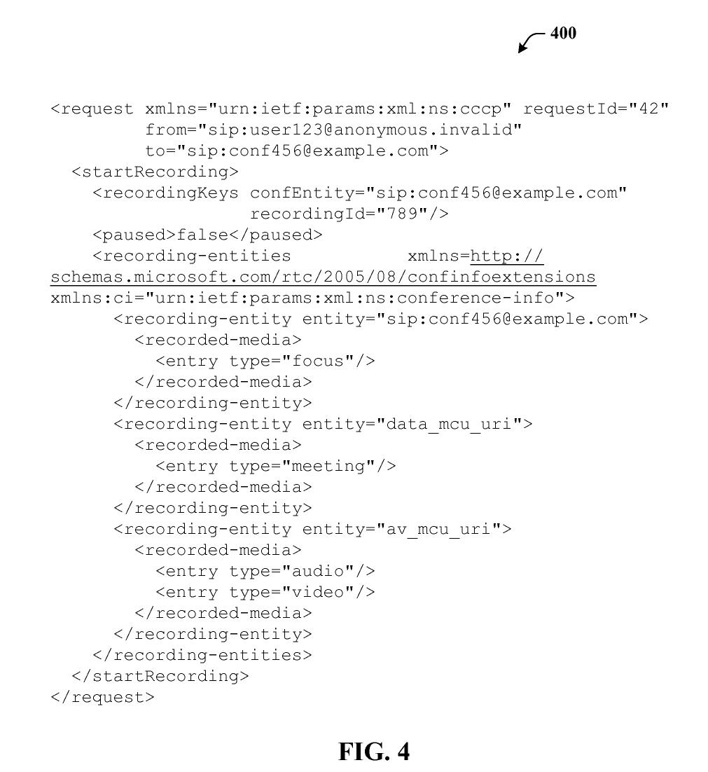

Referring to FIG. 3, FIG. 3 illustrates exemplary interactions between the illustrated components of the media archiver 108, the media producer 104, and a presenter attendee 102 according to one embodiment. Although FIG. 3 illustrates various protocols that can be used to communicate between the various components, one will appreciate that other protocols can alternatively be utilized in other embodiments. Recording is started when the presenter attendee client 102 sends appropriate messages in accordance with Centralized Conference Control Protocol (CCCP) over HTTP to the event controller component 212. FIG. 4 below illustrates an example Centralized Conference Control Protocol (CCCP) start recording request. The event controller component 212 uses either Persistent Shared Object Model Protocol (PSOM) and/or CCCP to interact with the MCU interface component 204. The MCU interface component interacts with the MCU client component 210 using CCCP over HTTP. The MCU client component forwards the archiver component 208 the media stream as it receives it. The MCU client component also interacts with the MCU 302 of the media producer 104 using both Session Initiation Protocol (SIP) and Real-time Transport Protocol (RTP). In other embodiments, the archiver component 210 can interact directly with the MCU 302.

FIG. 4 depicts an XML request 400 to start recording according to one embodiment. The illustrated XML request is performed in accordance with Centralized Conference Control Protocol (CCCP). The Centralized Conference Control Protocol sends the XML document over HTTP. Although FIG. 4 illustrates a start recording request, other recording related functionality (e.g., pause and stop) can be similarly conveyed to the media archiver service. Similarly, the media archiver can produce XML responses (not shown) in accordance with CCCP.

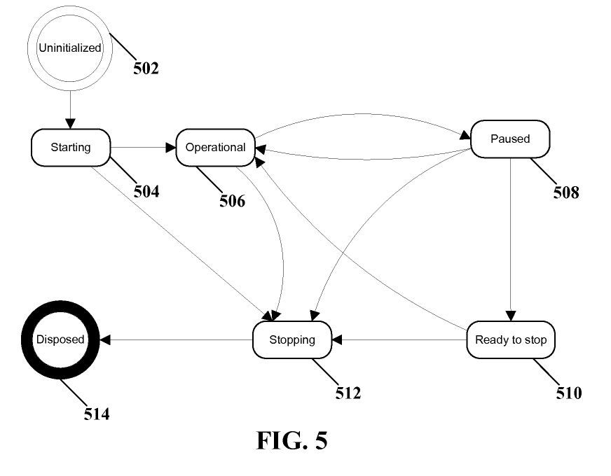

Referring to FIG. 5, a state diagram of the various states of a media archiver according to one embodiment is illustrated. The media archiver starts at the uninitialized state 502, such as before the service is started. The service is started and proceeds to the starting state 504. If the service starts normally, the service moves to the operational state 506 where it receives requests to record a live event and allocates components to record the event. If the service does not start normally, the service moves to the stopping state 512. Once the service is operational, the service can be stopped completely ending all current recordings and enter the stopping state 512 or the service can be paused 508 so that no additional recordings can be started by the service, such as if the service and/or machine will shutdown after all recordings are finished or there is not enough capacity for additional live event record recordings. If capacity becomes available, such as when a current recording ends, the media archiver can return to the operational state 506. After all current recordings are finished, the media archiver proceeds to the ready to stop state 510 where the service can be made available to new recordings (i.e. proceed to the operational state 506) or the service be stopped by entering the stopping state 512. After the service is stopped in the stopping state, it enters the disposed state 514.

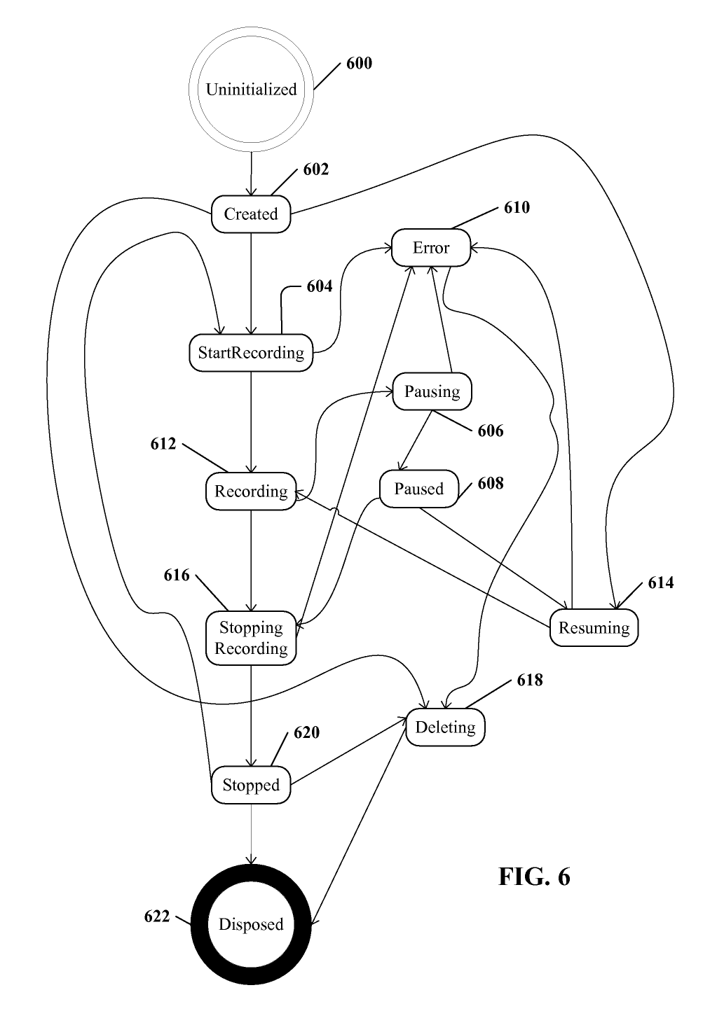

Referring to FIG. 6, a state diagram of various recording states for a single live event is illustrated. For the sake of simplicity, only a state of a single media stream is illustrated, however, each of the media streams of a live event can enter the illustrated states, either on an individual or collective basis. The uninitialized state 600 is the state of recording prior to the archiver component 208 and associated MCU client component 210 being allocated to record a media stream. After being allocated to record a stream, the state is changed to the created state 602. The component can be attached to a media stream and moves to the start recording state 604 when an indication is received to start recording and then proceeds to the recording state 612. In the recording state 612, the archiver component 208 is recording the media stream to a computer-readable storage medium. If an error occurs in starting the recording, the event state changes to the error state 610. When an error occurs the recording can be deleted by entering the deleting state 618. The error can be a protocol error (SIP error) or a media error (e.g., lost network connection). The recording can enter the stopping state 616 if an indication (e.g., a CCCP message) is received to stop recording.

The media stream can also be paused based on an indication (e.g., a CCCP message from the content presenter). At that point, the state is changed to the pausing state 606 and then enters the paused state 608. After receiving an indication to resume recording, the recording enters the resuming state 614 and returns to the recording state 612. If a paused stream is paused for too long (e.g., an hour), it can enter the stopping recording state 616. After the recording has been stopped 620, the recording proceeds to the disposed state 622. An indication can be sent at the stopped state 620, the deleting state 618 or the disposed state 622 so that post-processing by the archiver presenter 110 can be started and/or to allow the reallocation of the media archiver components for recording other live events.

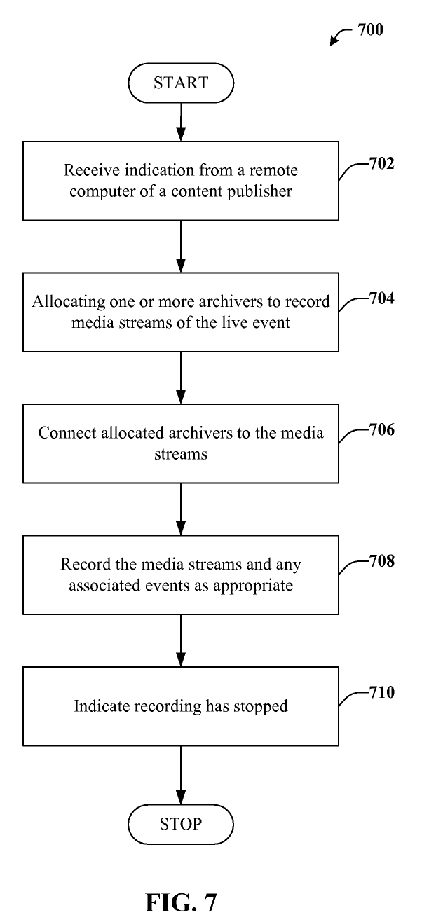

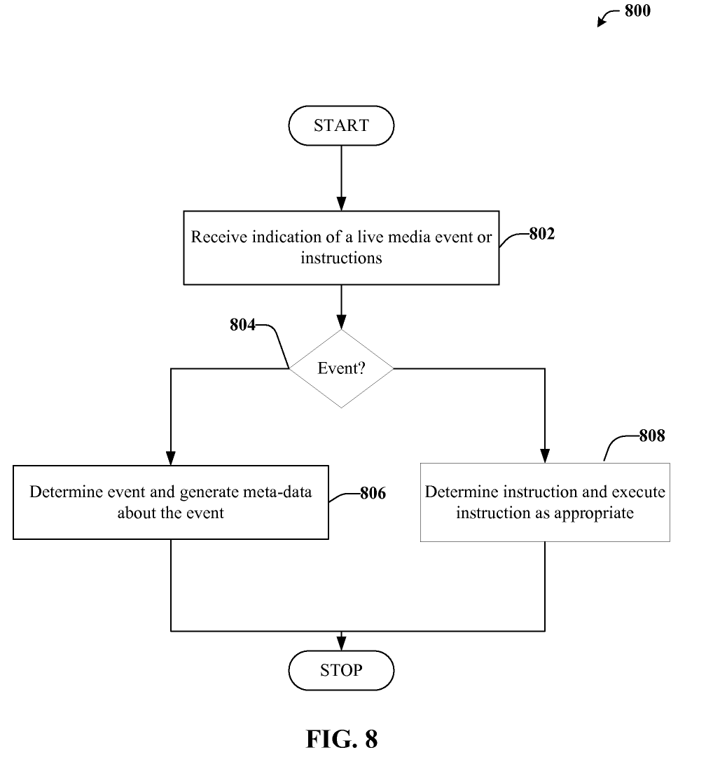

FIGS. 7 and 8 illustrate various methodologies in accordance with one embodiment. While, for purposes of simplicity of explanation, the methodologies are shown and described as a series of acts, it is to be understood and appreciated that the claimed subject matter is not limited by the order of acts, as some acts can occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media. Furthermore, it should be appreciated that although for the sake of simplicity an exemplary method is shown for use on behalf of a single user, the method may be performed for multiple users for different live events.

Referring now to FIG. 7, an exemplary method 700 for recording a live event is depicted. At 702, an indication is received from a remote computer, such as the remote computer of a content publisher. At 704, one or more achievers are allocated to record the media streams of the live event. Multiple media archivers can be allocated in some embodiments for failover reasons or legal reasons (e.g., media archivers in different countries). At 706, the allocated archivers connect to the media streams of the live event. At 708, after connecting, the allocated media streams are recorded as well any associated events. At 710, after recording has finished, an indication is made that recording has stopped. The indication can alert the content publisher and/or the archive presenter. The archive presenter can then start post processing of the recorded streams.

Referring now to FIG. 8, an exemplary method 800 is depicted during recording of the live streams, such as at 608 of FIG. 6. The method can be performed multiple times during a recording of one or more media streams. At 802, an indication is received of a live media event or instructions, such as from the content publisher. An event can include the switching between the presenter and a visual aid, a switch in the presenter of the live event, a switch of dominant speakers on a panel, etc. An instruction can include muting one or more streams, pausing one or more media streams, stopping one or more media streams, etc. At 804, it is determined if the received indication is an event. If so, at 806, the event is determined and meta-data is generated about the event. If not, at 808, the type of instruction is determined and the instruction is executed as appropriate. Thus, if the instruction is to pause the recording, the media stream being paused is prevented from recording, such as by temporarily disconnecting from the stream.

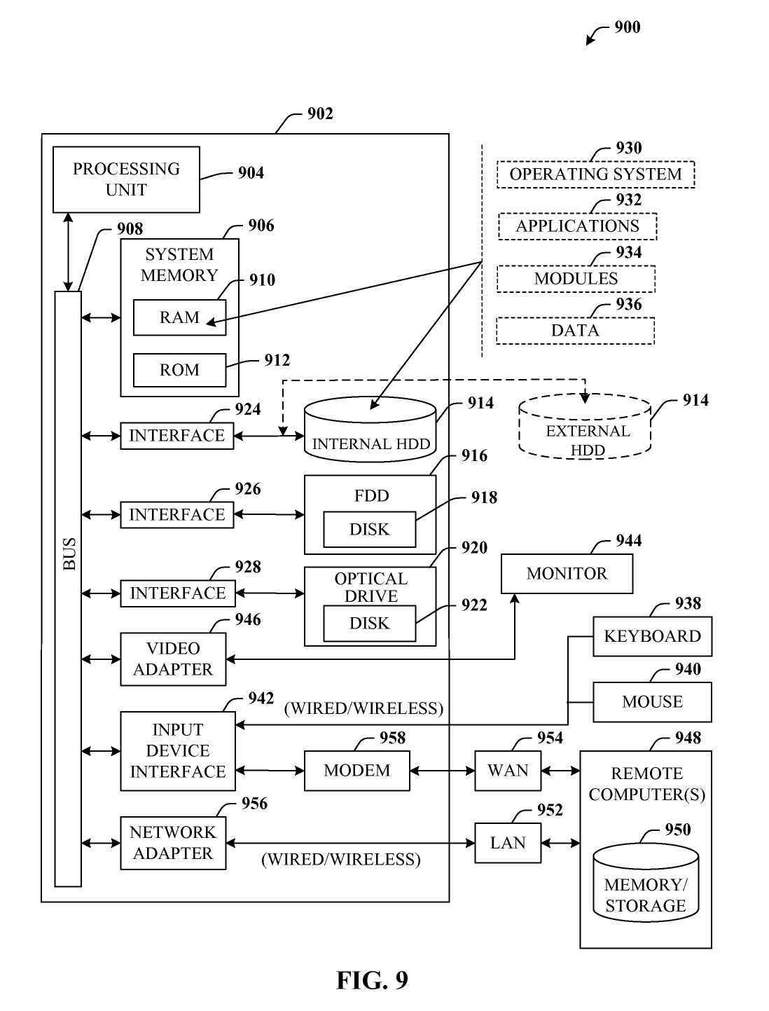

Referring now to FIG. 9, there is illustrated a block diagram of an exemplary computer system operable to execute one or more components of the disclosed media archiver. In order to provide additional context for various aspects of the subject invention, FIG. 9 and the following discussion are intended to provide a brief, general description of a suitable computing environment 800 in which the various aspects of the invention can be implemented. Additionally, while the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention can be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the invention includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, erasable programmable read-only memory (EPROM), electrically erasable programmable read-only memory (EEPROM), which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject invention.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a remote computers, such as a remote computer(s) 948. The remote computer(s) 948 can be a workstation, a server computer, a router, a personal computer, portable computer, microprocessor-based entertainment appliance, a peer device or other common network node, various media gateways and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A live event recording system, comprising:
an event controller component that receives an indication to record one or more media streams of a live event, the one or more media streams produced by a media producer;
a media client that maintains a connection with an indicated media producer, the media client not synchronously presenting the one or more media streams; and
an archiver component that records the one or more streams to a computer-readable storage medium.

2. The system of claim 1 wherein the event controller component receives the indication to record one or more media streams from a third-party content producer.

3. The system of claim 1 wherein the media producer is aware of at least one of: RTP, RTCP, SDP, or SIP.

4. The system of claim 1 wherein the media producer and the archiver component are located in close network proximity.

5. The system of claim 1 wherein the media producer is a Multipoint Control Unit (MCU) and the client is an MCU client.

6. The system of claim 1 wherein the one or more media streams includes at least two different types of media streams.

7. The system of claim 1 wherein the client is further configured to disconnect from the media producer when a pause is indicated by a content provider and reconnect the client when indicated to resume.

8. The system of claim 1 wherein the client is further configured to collect media events and generate metadata associated with at least one of the one or more media streams.

9. The system of claim 1, further comprising a publishing component that prepares the recorded one or more streams for asynchronous playback.

10. The system of claim 1 wherein the live event is a meeting with multiple presenters, at least some of the multiple presenters located at different locations.

11. The system of claim 1 wherein the media producer is a PSTN gateway.

12. A method of recording live events, comprising:
receiving an indication from a remote computer to record one or more indicated media streams of a live event;
connecting to the one or more media streams; and
recording the one or more media streams to computer-readable storage media, the recording performed without synchronously presenting the one or more streams.

13. The method of claim 12 further comprising publishing one or more files for asynchronous playback of the live event.

14. The method of claim 12, further comprising:
receiving an indication from a second remote computer to record one or more indicated media streams of a live event;
connecting to the one or more media streams indicated by the second remote computer; and
recording the one or more media streams indicated by the second remote computer to computer-readable storage media, the recording performed without synchronously presenting the one or more streams.

15. The method of claim 12 wherein the remote computer and a computer performing the method are in close network proximity.

16. The method of claim 12, further comprising:
pausing the recording of at least one of the one or more media streams in response to an indication by the first content publisher; and
resuming the recording of the at least one stream in response to an indication by the first content publisher.

17. The method of claim 12, further comprising:
analyzing at least one of the one or more media streams for media events associated with the live event; and
generating meta-data based at least in part on the media events.

18. The method of claim 12 wherein the indication from the remote computer is sent via Centralized Conference Control Protocol (CCCP).

19. A computer-readable medium having computer-executable instructions for performing the method of claim 12.

20. A meeting recording system comprising:
means for receiving an indication to record a meeting from a content provider and allocating a recording means for the meeting in response to the indication, the meeting broadcast in one or more live media streams; and
means for recording the one or more media streams to a computer-readable storage medium without synchronously presenting the one or more media streams.
